(19) United States
(12) Patent Application Publication
(10) Pub. No.: US 2025/0279456 A1
(43) Pub. Date: Sep. 4, 2025

(54) CONNECTOR DEVICE AND FUEL CELL STACK HAVING SUCH A CONNECTOR DEVICE

(71) Applicant: HARTING Customised Solutions GmbH & Co. KG, Espelkamp (DE)

(72) Inventors: Rudolf NIENABER, Espelkamp (DE); Tarek SPREEN, Espelkamp (DE); Matthias WIEHE, Espelkamp (DE); Danny HÖRIG, Espelkamp (DE); Bo WANG, Espelkamp (DE)

(21) Appl. No.: 19/059,610

(22) Filed: Feb. 21, 2025

(30) Foreign Application Priority Data
Feb. 29, 2024 (DE) 10 2024 105 790.4

(51) Int. Cl. H01M 8/2465; F16B 5/00; H01M 8/10; H01M 8/241

(52) U.S. Cl. CPC H01M 8/2465; F16B 5/00; H01M 8/241; H01M 2008/1095

(57) ABSTRACT

A connector device for a fuel cell stack is provided. Furthermore, a fuel cell stack is provided, comprising at least one such connector device. The connector device includes a scissor lifting mechanism having at least two mechanically coupled pairs of scissor elements and at least three contact modules arranged equidistantly from one another on the scissor lifting mechanism, wherein each contact module is set up and arranged to be electrically coupled to an electrically conductive element of the fuel cell stack.

### BACKGROUND

### Technical Field

The disclosure relates to a connector device for a fuel cell stack. Furthermore, the disclosure relates to a fuel cell stack comprising at least one such connector device.

### Description of the Related Art

Electrochemical devices such as fuel cells or electrolyzers are known from the prior art. In particular, hydrogen PEM electrolysis stacks and PEM fuel cell stacks are known, which are technically constructed almost identically. In the context of this disclosure, “PEM” stands for “Proton Exchange Membrane” and refers to the type of cell used in the stack.

A hydrogen PEM electrolysis stack is a part of a hydrogen electrolyzer used to produce hydrogen. In the PEM electrolysis stack, water is broken down into its components, hydrogen and oxygen, by applying an electrical voltage. The proton exchange membrane in the cell allows hydrogen ions (protons) to be transported through the membrane while electrons flow through an external electrical circuit. As a result, water is broken down into its components. Hydrogen is generated at the anode while oxygen is formed at the cathode. The electrolysis stack consists of a number of individual cells that are electrically connected to one another. This stacking increases the efficiency and performance of the electrolyzer. PEM technology is efficient and responds quickly, making it suitable for various applications such as hydrogen production for fuel cell vehicles or renewable energy storage. Thus, a PEM electrolysis stack uses electrical current to break down water into hydrogen and oxygen. This means hydrogen electrolyzers are used for hydrogen production.

PEM fuel cells use the reverse process to generate electrical energy from hydrogen. In a fuel cell, hydrogen reacts with oxygen from the air, producing water as a byproduct and generating electrical energy and heat. Fuel cells can be used as energy sources to provide electrical energy for vehicles, stationary power generation, and other applications. They are used to convert the hydrogen produced into electrical energy and can be utilized as alternative energy storage and to reduce emissions.

Hereinafter, these types of fuel cell stacks are referred to as PEM stacks because both PEM electrolysis and PEM fuel cells use a proton exchange membrane (PEM).

Bipolar plates are placed between the individual cells of a stack as electrically conductive layers. They are used to establish electrical contacts between the individual cells and to conduct the electrical current through the stack. In addition, the bipolar plates can be used as structural elements to support the individual cells and to guide the flow of hydrogen and oxygen within the stack. In addition, bipolar plates can also act as heat sinks to regulate the temperature within the cell. For this purpose, the bipolar plates can be thermally coupled to a cooling system.

In addition to the PEM stacks described above, the term “fuel cell stack” is also understood to mean other well-known types, such as, for example, solid oxide fuel cell stacks (SOFC), solid oxide electrolysis stacks (SOEC) or carbon fuel cell stacks (DMFC).

For the purpose of monitoring the individual cells of the fuel cell stack, the voltages of the individual cells are measured and evaluated. This setup is also known as “cell voltage monitoring” (“CVM” for short). In a typical CVM unit design, the plurality of individual cells in the stack are connected and wired individually, which results in considerable measurement effort.

The series connection of the cells in the stack results in a potential hazard, wherein the failure of one or more individual cells can lead to the failure and/or shutdown of the entire stack. At the same time, the connections of the individual cells for voltage monitoring cannot always be arranged equidistantly, i.e., with a constant distance, due to production reasons, in particular due to variable bipolar plate thicknesses. In addition, the distances between the cells change by up to 5% during operation due to temperature effects.

### BRIEF SUMMARY

Embodiments of the present disclosure provide a connector device which makes an electrical contact for cell voltage monitoring resistant to production-related tolerances and/or operational, in particular temperature-related, distance changes.

A connector device according to the disclosure for a fuel cell stack comprises a scissor lifting mechanism having at least two mechanically coupled pairs of scissor elements and at least three contact modules arranged equidistantly from one another on the scissor lifting mechanism, wherein each contact module is set up and arranged to be electrically coupled to an electrically conductive element of the fuel cell stack.

The connector device can be described as a variable equidistance connector, which can change the distances between the contact modules of the cells variably and equidistantly. Equidistant in this context means “at equal distance” or “evenly distributed.” If the contact modules are arranged equidistantly, this means that the distances between the contacts of the individual cells are always the same. This means that the contact modules are distributed at the same distance. If the distances between the bipolar plates or the contact modules can be changed variably and equidistantly, this means that the distances between these elements can be changed variably, while at the same time ensuring that all distances between the adjacent contact modules always remain the same. In other words, regardless of the adjustments, the distances between the contact modules remain evenly distributed or the same distance from each other. The scissor lifting mechanism can therefore compensate for production-related tolerances during assembly. On the other hand, the scissor lifting mechanism is resistant to temperature-related distance changes that may occur during operation.

The scissor lifting mechanism is a rod mechanism and consists of at least four scissor elements or at least two pairs of scissor elements. Each pair of scissor elements therefore has two scissor elements connected to one another in a scissor-like manner. The scissor elements are understood to mean levers or bars of the scissor lifting mechanism, which preferably cross in the middle at a joint and thus form a scissor structure. In this sense, the phrase “scissor-like connected” is understood to mean a connection or construction in which two or more elements are connected to one another by joints or hinges. Typically, these elements are arranged in such a way that they can either move apart or spread or contract, similar to the opening or closing of scissors. This configuration offers stability and the possibility of carrying out movements in a certain direction, preferably in the longitudinal direction of the scissor lifting mechanism or in the longitudinal direction of the stacked cells of the fuel cell stack.

Each pair of scissor elements is formed in each case by two scissor elements, each of which is articulated at its lower end with an upper end of an adjacent pair of scissor elements by way of bearing pins, flat rivets or the like, and each of which is articulated at its upper end with a lower end of an adjacent pair of scissor elements on the opposite side. The respective pair of scissor elements at the respective axial end of the scissor lifting mechanism can, if necessary, be attached to a housing or other elements, with the scissor elements only being connected on one side to the scissor elements of the adjacent pair of scissor elements.

Opening or closing the scissor elements creates a linear movement of the scissor lifting mechanism, wherein the distance between the joints of the pairs of scissor elements is always equidistant, regardless of the number of pairs of scissor elements. The scissor mechanism enables a robust and stable lifting movement while requiring relatively little space.

The scissors mechanism can be operated manually, that is to say with hands, wherein the scissors elements of the respective pair of scissors elements are spread out or contracted by axially pulling the scissors mechanism apart or compressing it. That is to say, the scissors mechanism can be extended or compressed axially. This makes it possible to provide a connector device that is only flexibly adapted to the existing conditions as required during assembly. As a result, the distance between the contact modules is therefore only varied when the connector is assembled. This means that the connector device proposed here has one design and can be used in different areas of application with different cell thicknesses and/or bipolar plate thicknesses and can be adapted to the conditions in a modular manner. This significantly reduces the effort required for assembly and electrical test technology connection, and the probability of errors is significantly reduced. In particular, an error-minimized installation concept for fuel cell stacks can be implemented.

The respective contact module is arranged substantially transversely to the stretching or compression direction of the scissor lifting mechanism, i.e., transversely to its longitudinal direction, and extends away from the scissor lifting mechanism in the direction of the fuel cell stack. The number of contact modules corresponds to the number of cells of the fuel cell stack to be monitored. In one embodiment, the number of contact modules corresponds to the number of individual cells of the fuel cell stack, thus implementing individual cell monitoring for the fuel cell stack.

Preferably, one contact module is arranged in each case at a free end of a pair of scissor elements or in a coupling region between two adjacent pairs of scissor elements in relation to a longitudinal direction of the scissor lifting mechanism. This enables a stable and positionally accurate arrangement of the respective contact module on the scissor lifting mechanism to be implemented.

In this sense, the contact module has an insulating body which, when the contact module is arranged at the free end of a pair of scissor elements, is connected via a first guide pin to a first scissor element of the associated pair of scissor elements and via a second guide pin to a second scissor element of the same pair of scissor elements, or which, when the contact module is arranged in the coupling region between two adjacent pairs of scissor elements, is arranged via a first guide pin to a first joint connecting the adjacent pairs of scissor elements and via a second guide pin to a second joint connecting the same pairs of scissor elements. The contact modules can thus be connected to the joints of the scissor lifting mechanism, which are provided anyway for the articulated connection between the pairs of scissor elements, in particular without any load.

The cutting plane in which a pair of scissor elements is connected to an adjacent pair of scissor elements is understood to mean a coupling region. Since each pair of scissor elements consists of two scissor elements, each coupling region comprises two connection points for the articulated connection of the first scissor element of the first pair of scissor elements to a second scissor element of the adjacent second pair of scissor elements and the second scissor element of the first pair of scissor elements to a first scissor element of the adjacent second pair of scissor elements. The joints are designed in such a way that the articulated scissor elements can rotate relative to one another about an axis of rotation.

The guide pins can be connected in one piece to the structural components that form the joints of the scissor lifting mechanism. The guide pins can therefore directly form the joints of the scissor lifting mechanism, which are provided for the articulated connection of two scissor elements of two adjacent pairs of scissor elements. Alternatively, the guide pins can be subsequently connected to the structural components that form the joints of the scissor lifting mechanism, in particular the bearing pins or flat rivets. In this sense, the bearing pins or flat rivets can, for example, have internal threads into which the guide pins are screwed when the respective contact module is mounted on the scissor lifting mechanism. Pressing the guide pins into a receptacle on the bearing pin or flat rivet is also conceivable.

The guide pins are configured and arranged on the scissor lifting mechanism in such a way that they attach the insulating body to the scissor lifting mechanism in a positionally accurate manner. The guide pins are preferably screws with a threaded section and a screw head that, when mounted, is supported axially on the insulating body in order to secure it in the axial direction of the contact module.

The insulating body is formed of an electrically insulating material, preferably plastic, and protects the electrically conductive components arranged within the insulating body from interaction with external structural components or external influences. The insulating body is preferably protected against the ingress of solid foreign bodies with a diameter greater than 12.5 mm, such as fingers, in accordance with the IP20 classification, but does not offer any specific protection against moisture.

Preferably, the first guide pin is guided through a slot-shaped first through-bore of the insulating body, the second guide pin being guided through a second through-bore of the insulating body, which is complementary to the external geometry of the second guide pin. The slot on the first through-bore ensures a constraint-free movement and rotation of the scissor elements when the scissor lifting mechanism tapers when stretched or widens when compressed. If the second guide pin has a substantially circular cross-section, the second through-bore also has a substantially circular cross-section.

The contact module preferably has an insert for receiving a contact holder, wherein the insert is at least partially surrounded by the insulating body. The insert is preferably arranged in a latching manner on the insulating body. A latching mechanism is therefore provided on the insulating body, via which the insert can be attached to the insulating body.

The function of the insert is to receive the contact holder, on which a pre-assembled wire can be arranged for the electrical connection of the respective cell of the fuel cell stack with the measurement technology. In other words, the contact holder can be inserted into the insert together with the wire. The insert can then be inserted into the insulating body together with the contact holder and attached to it. The attachment to the insert can be done by snapping or clipping, for example. Pre-assembled wires are cables or lines that are already provided with connectors, sockets or other connection devices. In contrast to unassembled wires, which only have raw cables, pre-assembled wires are ready for use and can be connected directly to devices or other components without the need for additional assembly or configuration. This can simplify and speed up the installation and replacement of connections.

Depending on the configuration, the insert is designed as a connector or socket and receives a contact holder, which is configured to be complementary to the geometry of the electrically conductive element of the fuel cell stack. The contact holder is, for example, a flat plug sleeve, a connection or a socket, in particular an RJ45 receptacle or socket for patch cables. It is also conceivable to provide a flat steel or a sheet metal section as a contact holder on the connector device sides, which is plugged into a complementary socket or the like on the fuel cell stack side when the connector device is mounted on the fuel cell stack.

The external geometry of the insert can always be adapted to the internal geometry of the insulating body, regardless of the area of application. Only the internal geometry of the insert can be adapted to the specific application, that is to say depending on the construction and shape of the contact holder. This makes it easier to have a modular construction of the connector device, since only the insert needs to be replaced depending on the specific application, while the rest of the connector device, i.e., the scissor lifting mechanism and the insulating body of the contact module, can remain identical. The insert is preferably configured and arranged on the insulating body in such a way that it covers the mounting opening through which the respective guide pin is mounted, in an electrically insulating manner.

According to an exemplary embodiment, the insulating body comprises or consists of at least two components. In other words, the insulating body is designed in two or more parts. This means that the insert with the contact holder can be arranged interchangeably on the insulating body.

The contact holder can be designed as a flat plug sleeve. In another embodiment, the contact holder can also be designed as a contact element, as a pin or socket contact, or can comprise such a contact element. The contact elements are rigidly mounted, i.e., not spring-loaded.

In a further embodiment, the entire plug-in device is designed as a connector.

The disclosure includes the technical teaching that the scissor elements are formed from an electrically non-conductive material. In particular, the pairs of scissor elements are formed from an electrically non-conductive material, for example plastic or steel. While plastic, in particular glass fiber reinforced plastic, has a positive effect on the overall weight of the connector device, steel scissor elements can be manufactured particularly easily, for example by stamping.

Preferably, means or devices for manually setting a length of the scissor lifting mechanism are arranged on the scissor lifting mechanism. In other words, shaped elements or handles can be arranged on individual scissor elements, preferably on a first scissor element or first pair of scissor elements at a distal end of the scissor lifting mechanism and on a second scissor element or second pair of scissor elements at an opposite distal end of the scissor lifting mechanism, in order to simplify handling of the connector device, in particular to be able to manually stretch or compress the scissor lifting mechanism at least indirectly. As a result, the distances between the contact modules can therefore be set variably and as desired. This allows a variable pre-setting of the scissor lifting mechanism to take place during assembly of the connector device, before or while the scissor lifting mechanism is arranged on the fuel cell stack and connected to its electrically conductive elements.

The means or devices mentioned can be used in addition to the arrangement of the scissor lifting mechanism on a housing. The housing can protect the connector device from external influences. Alternatively, the scissor lifting mechanism can have separate means or devices for attaching the scissor lifting mechanism to a housing. The means or devices for attaching the scissor lifting mechanism to the housing can be designed in the form of handles or shaped elements.

A fuel cell stack according to the disclosure comprises at least one connector device according to the above statements. The respective connector device is set up and designed to electrically connect the fuel cell stack, in particular the cells of the fuel cell stack, to a system for voltage monitoring of the fuel cell stack, in particular for individual voltage monitoring of the individual cells of the fuel cell stack. In the case of complex fuel cell stacks and depending on the scope of the measurement technology, the fuel cell stack can also comprise two or more than two connector devices according to the disclosure. The fuel cell stack is preferably a PEM stack, in particular a PEM electrolysis stack or a PEM fuel cell stack.

The above definitions as well as statements on technical effects, advantages and advantageous embodiments of the connector device according to the disclosure according to the first aspect of the disclosure also apply mutatis mutandis to the fuel cell stack according to the disclosure according to the second aspect of the disclosure, and vice versa.

It is understood that the features mentioned above and those to be explained below can be used not only in the combination specified in each case, but also in other combinations or on their own, without departing from the scope of the present disclosure.

### BRIEF DESCRIPTION OF THE SEVERAL VIEWS OF THE DRAWINGS

FIG. 1 shows a highly simplified representation of a fuel cell stack according to the disclosure with a connector device according to the disclosure,

FIG. 2 shows a highly simplified view of a scissor lifting mechanism of the connector device according to the disclosure,

FIG. 3 shows a highly simplified side view of the connector device according to the disclosure, and

FIG. 4 shows a highly simplified plan view of a contact module of the connector device according to the disclosure.

### DETAILED DESCRIPTION

According to FIG. 1, a fuel cell stack 1, here for example in the form of a PEM electrolysis stack or a PEM fuel cell stack, is shown very schematically and only by way of example and without limitation. Fuel cell stacks can be used, for example, to drive at least partially electrically powered vehicles. PEM electrolysis stacks can be used to produce hydrogen.

Fuel cell stack 1 comprises a stack of individual electrochemical cells 2, only some of which are provided with reference numerals. In particular, individual cells 2 typically consist of two bipolar plates—not shown here—which have flow fields for the media on their opposite sides and often a flow field for a cooling medium inside. A so-called membrane electrode assembly (“MEA” for short) is arranged between two of these bipolar plates, which has an anode, a cathode and a membrane as an electrolyte in between. Furthermore, gas diffusion layers (“GDL” for short) are provided, via which the supplied gases, typically hydrogen and oxygen or hydrogen and air, can reach the electrodes evenly. The gas diffusion layers are also electrically conductive and connect the respective bipolar plates to the electrodes. One surface of the bipolar plate forms an anode side, the other forms a cathode side, so that by stacking the bipolar plates alternately in the same orientation, fuel cell stack 1 is stacked and individual cells 2 are electrically connected in series. In fuel cell stacks in vehicles in particular, it is not unusual to provide 300 to 400 individual cells 2. Fewer or more individual cells 2 are of course also conceivable depending on the required electrical power. Individual cells 2 are understood to mean electrically conductive elements of fuel cell stack 1.

For safe and reliable operation and optimal performance of fuel cell stack 1, it is necessary to monitor individual cells 2, in particular their voltage. Various influences can lead to an undersupply, damage or failure of individual cells 2, so that they cannot deliver any voltage or the typical voltage.

In order to be able to recognize these critical situations early on and counteract them if necessary, individual cell voltage monitoring of individual cells 2 is typically carried out. For this purpose, a CVM unit 3 is provided for monitoring the individual cell voltages of all individual cells 2 of fuel cell stack 1. CVM unit 3 is electrically connected to each individual cell 2 to be monitored via a connector device 4 according to the disclosure. In FIG. 1, only a single line is shown between connector device 4 and CVM unit 3. This line is intended to simply illustrate that one electrical line each is arranged between a contact module 10 and the CVM unit 3. In this exemplary embodiment, fuel cell stack 1 also comprises two end plates 11, between which stacked individual cells 2 are arranged, thus realizing a simple, secure connection that can also be detached for maintenance purposes if necessary.

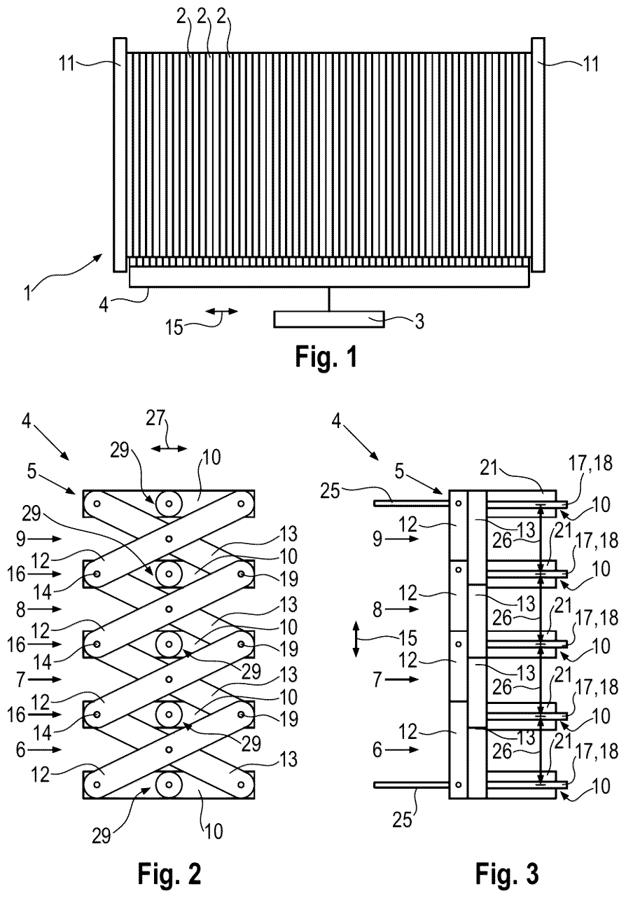

FIGS. 2 to 4 show a simplified and not completely illustrated structure of the connector device 4. According to FIGS. 2 and 3, the connector device 4 comprises a scissor lifting mechanism 5 with a plurality of mechanically coupled pairs of scissor elements 6, 7, 8, 9. Here, only four pairs of scissor elements 6, 7, 8, 9 are shown by way of example in order to illustrate the functioning of connector device 4 in a simplified manner, without showing entire connector device 4 in detail.

A number of contact modules 10 corresponding to the number of individual cells 2 according to FIG. 1 are arranged on scissor lifting mechanism 5, which function as electrical coupling pieces for the electrical connection of CVM unit 3 according to FIG. 1 on the one hand and individual cells 2 on the other hand.

It should be understood that the number of pairs of scissor elements 6, 7, 8, 9 and contact modules 10 can be adapted to the number of electrically conductive elements of fuel cell stack 1. Due to the simple structure of connector device 4, individual pairs of scissor elements and corresponding contact modules can be easily removed or added.

Pairs of scissor elements 6, 7, 8, 9 are designed such that contact modules 10 are arranged equidistant from one another. Each pair of scissor elements 6, 7, 8, 9 has two scissor elements 12, 13 in each case. A first scissor element 12 of the first pair of scissor elements 6 is articulated via a first joint 14 with a second scissor element 13 of the adjacent second pair of scissor elements 7. A second scissor element 13 of the first pair of scissor elements 6 is articulated via a second joint 19 with a first scissor element 12 of the same second pair of scissor elements 7. This is analogously applicable for each further pair of scissor elements 7, 8, 9, as can be clearly seen in FIG. 2. Scissor elements 12, 13 are formed from an electrically non-conductive material. In the present case, all first scissor elements 12 are formed identically, wherein all second scissor elements 14 are formed in a mirror-inverted manner relative to first scissor elements 12.

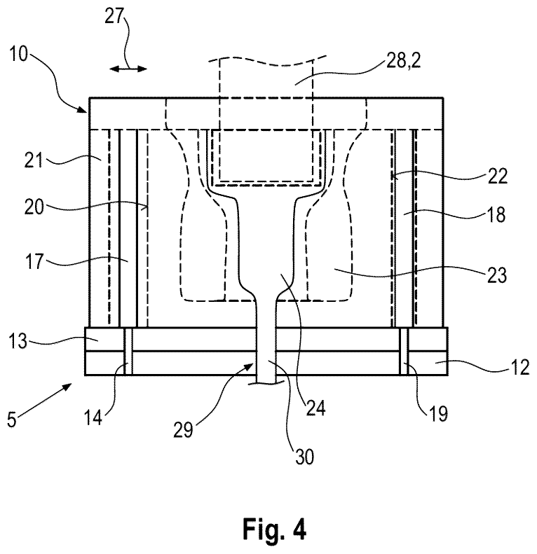

In the present case, in relation to a longitudinal direction 15 of connector device 4, one contact module 10 is arranged at each of the free ends of scissor lifting mechanism 5 or scissor elements 12, 13 of first and fourth pairs of scissor elements 6, 9. Further contact modules 10 located in between are each arranged in a coupling region 16 between two adjacent pairs of scissor elements 6, 7 or 7, 8 or 8, 9, wherein contact modules 10 are arranged on scissor lifting mechanism 5 via two guide pins 17, 18 each. Guide pins 17, 18 are indicated in FIGS. 3 and 4.

Contact modules 10 at the free ends of the first and fourth pair of scissor elements 6, 9 are connected in the present case via first guide pin 17 to a first scissor element 12 of associated pair of scissor elements 6, 9 and via second guide pin 18 to a second scissor element 13 of same pair of scissor elements 6, 9.

Contact modules 10 in coupling region 16 between two adjacent pairs of scissor elements 6-9 are arranged via respective first guide pin 17 with first joint 14 connecting adjacent pairs of scissor elements 6-9 in each case and via second guide pin 18 on second joint 19 connecting the same pairs of scissor elements 6-9 on the scissor lifting mechanism 5. A first guide pin 17 is arranged in each case coaxially to an associated first joint 14 and a second guide pin 18 is arranged in each case coaxially to an associated second joint 19.

According to FIG. 3, means or devices for manually setting a length of scissor lifting mechanism 5 are also arranged on scissor lifting mechanism 5. In the present case, these means or devices are designed as handles 25 in order to manually set a length of the scissor lifting mechanism or a distance 26 between contact modules 10. Scissor lifting mechanism 5 is designed in such a way that, regardless of the set total length of the scissor lifting mechanism 5, individual distances 26 between any two contact modules 10 are always the same size, i.e., equidistant.

FIG. 4 shows that first guide pin 17 is guided through a slot-shaped first through-bore 20 of an insulating body 21 of contact module 10. Furthermore, second guide pin 18 is guided through a second through-bore 22 of insulating body 21, which is complementary to the external geometry of second guide pin 18. In other words, respective contact module 10 is arranged and held in position on the one hand by second guide pin 18 and complementary second through-hole 22 on scissor lifting mechanism 5, while on the other side of contact module 10 a movement of first guide pin 17 within first through-hole 20 in transverse direction 27, which is laterally limited by the slot-shaped geometry of first through-hole 20, is released when scissor lifting mechanism 5 is compressed or stretched or when scissor lifting mechanism 5 widens during compression and tapers during stretching.

Insulating body 21 of contact module 10 is divided into two parts—in a form not shown here—and is formed from an electrically insulating material. An insert 23 for receiving a contact holder 24 is also arranged within insulating body 21, with contact holder 24 in turn being arranged within insert 23. In the present case, contact holder 24 is designed as a flat plug sleeve, with a sheet-like, flat section 28 of the electrically conductive element or the bipolar plate being pushed into contact holder 24 during assembly and electrically connected thereto. Insert 23 is formed from an electrically insulating material and extends over almost the entire front surface of scissor lifting mechanism 5, with the exception of an opening—not shown here—for receiving section 28 on contact holder 24. As a result, the openings through which guide pins 17, 18 are mounted on scissor lifting mechanism 5 are also covered in an electrically insulating manner by the insert.

According to FIG. 4, on a side of contact module 10 opposite section 28 of the electrically conductive element or fuel cell stack 1, a feedthrough 29 is formed for leading a strand 30 electrically connected to contact holder 24 or an electrical line out of contact module 10 in order to electrically connect contact module 10 to CVM unit 3 according to FIG. 1. Feedthrough 29 is also indicated in FIG. 2.

Connector device 4 is designed such that scissor lifting mechanism 5 can implement a length change of at most 10% in relation to its total length in longitudinal direction 15. This prevents shearing of strand 30 or the electrical lines that each connect a contact module 10 to CVM unit 3, while at the same time ensuring that individual cells 2 are always arranged equidistantly, i.e., at same distance 26 from one another, even in the event of expansion due to temperature changes, for example.

German patent application no. 10 2024 105 790.4 filed, filed Feb. 29, 2024, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A connector device for a fuel cell stack, comprising:
a scissor lifting mechanism having at least two mechanically coupled pairs of scissor elements; and
at least three contact modules arranged equidistantly from one another on the scissor lifting mechanism, wherein each contact module is set up and arranged to be electrically coupled to an electrically conductive element of the fuel cell stack.

2. The connector device according to claim 1, wherein in each case one contact module is arranged with respect to a longitudinal direction of the scissor lifting mechanism at a free end of a pair of scissor elements or in a coupling region between two adjacent pairs of scissor elements.

3. The connector device according to claim 2, wherein the contact module has an insulating body which, when the contact module is arranged at the free end of a pair of scissor elements, is connected via a first guide pin to a first scissor element of the associated pair of scissor elements and via a second guide pin to a second scissor element of the same pair of scissor elements, or which, when the contact module is arranged in the coupling region between two adjacent pairs of scissor elements, is connected via a first guide pin to a first joint connecting the adjacent pairs of scissor elements and via a second guide pin to a second joint connecting the same pairs of scissor elements.

4. The connector device according to claim 3, wherein the first guide pin is guided through a slot-shaped first through-bore of the insulating body, and wherein the second guide pin is guided through a second through-bore of the insulating body which is complementary to the external geometry of the second guide pin.

5. The connector device according to claim 4, wherein the contact module has an insert for receiving a contact holder, wherein the insert is at least partially surrounded by the insulating body.

6. The connector device according to claim 3, wherein the insulating body comprises at least two components.

7. The connector device according to claim 1, wherein the scissor elements of the pairs of scissor elements are formed from an electrically non-conductive material.

8. The connector device according to claim 1, wherein one or more devices for manually setting a length of the scissor lifting mechanism are arranged on the scissor lifting mechanism.

9. The connector device according to claim 1, wherein the contact holder is formed as a contact element or has such a contact element.

10. A fuel cell stack, comprising at least one connector device according to claim 1.

11. The fuel cell stack according to claim 9, wherein the fuel cell stack is a PEM electrolysis stack or a PEM fuel cell stack.
